(19) United States
(12) Patent Application Publication
(10) Pub. No.: US 2002/0009180 A1
(43) Pub. Date: Jan. 24, 2002

(54) Fail to pots architecture

(76) Inventors: Andreas Weirich, Stittsville (CA); Gudmundur Hjartarson, Nepean (CA); Allan Isfan, Kanata (CA)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/811,382

(22) Filed: Mar. 15, 2001

(30) Foreign Application Priority Data
Mar. 31, 2000 (CA) 2,303,635

(51) Int. Cl. H04M 1/24

(52) U.S. Cl. 379/1.01; 379/22.03

(57) ABSTRACT

A system for providing at least one telephone service in a multiservice communication system, the system comprising a combiner for combining a plurality of services for delivery between a source and a user along a common line. A decombiner recovers the plurality of services from the common line, a detector detects a failure condition in at least one of the combiner or the decombiner, and a switch responsive to the detected failure bypasses the failed combiner or decombiner to couple at least one service determined to be critical between the source and the user. This allows an improved response to loss of power than many exiting systems.

This invention relates to a method and system for decreasing the effect of loss of power or data path on telephone customer premises equipment, and more particularly to equipment connected to pair gain devices.

### BACKGROUND OF THE INVENTION

Twisted pair copper loops are the physical transmission facility for various types of signals from a telephone central office (CO) to telephony equipment, such as analog telephone terminals, facsimile machines and voiceband data modems, at a customer's premises. With increasing demand for additional telephony services, there is commensurate increasing demand for copper loop transmission facilities. However, demand for additional physical copper loops cannot always be satisfied since only a limited number of copper loops have been installed by telephone operating companies, typically averaging 1.2 loops per residence. Therefore, when the demand in a given area exceeds the number of installed physical loops in that area, some customers cannot be provided with additional services. This problem is sometimes called “copper exhaust”, and can cause frustration for a customer and a loss of potential revenue for the telephone operating company.

Several technologies, all of which multiplex multiple services (most often voice or plain old telephone service—POTS) onto a single copper pair and generically known as “pair gain” or sometimes also Digital Added Main Line (DAML), have been developed to solve this problem. Systems employing pair gain technologies require customer premises equipment (CPE) at the customer end (home, office, etc.) of the copper loop that communicates with special equipment at the service provider end of the copper loop.

Typical pair gain system architecture is shown in FIG. 1. The system includes a pair gain central office terminal (COT) 24 at the telephone central office (CO) or at a digital loop concentrator (DLC) remote terminal (RT) 12. The pair gain COT 24 is connected to a telephone switch line access peripheral or to a DLC 12 to receive multiple voice signals, usually by means of analog POTS interfaces. The multiple voice channels are connected to the pair gain COT device 24, which impresses a signal containing the multiplexed voice channels onto a single twisted pair copper loop 26. A pair gain CPE device 28 receives the multiplexed signal, separates the constituent voice channels, and provides individual analog POTS interfaces for each voice channel to connect to customer terminals, such as telephones, facsimile machines, etc.

Because the pair gain CPE device 28 may require more power in order to operate its circuitry than can typically be provided by an access peripheral (or DLC RT) 12 line card 20, the additional power requirements may be satisfied by a power supply 30 which derives its power from the local alternating current (AC) mains. If a local power outage disrupts the AC main power, communication using the pair gain CPE 28 becomes impossible until the AC main power is restored. The disruption of telephone service is problematic for subscribers who are accustomed to telephone service being available despite power outages. This is especially true in the event of a life or security threatening emergency situation.

Uninterruptable AC power supplies (UPS) are commercially available and can provide AC power for a short time in the event of a local AC main power outage. However, the disadvantages of local UPSs are their purchase and maintenance cost, the limited time these devices can supply power, and the regular maintenance that is required to ensure they are operational in the event of a power outage.

A typical solution to the provision of uninterruptable power to a pair gain device is to provide power from an UPS at the CO over the twisted pair copper loop 28 by means of a high voltage power supply 30 coupled onto the copper loop 28 at the pair gain COT device 24. In order to provide sufficient power through the electrical resistance of the copper loop 26 to the pair gain CPE 28, the power supply must impress a high voltage, typically 130 volts, onto the loop. This solution is costly since it requires special circuitry at the pair gain COT 24 to generate and couple the high voltage supply to the copper pair 26. Such a high voltage is also potentially hazardous to persons who might come into physical contact with the copper loop 26.

### BRIEF SUMMARY OF THE INVENTION

The present invention seeks to provide a system and method that allows a pair gain CPE to be powered locally, which is more convenient, less costly, and less hazardous but also provides access to a primary POTS line during a local power failure or loss of pair gain COT or pair gain CPE function.

In accordance with this invention there is provided a system for providing at least one service in a multiservice communication system, the system comprising:

(a) a combiner for combining a plurality of services for delivery between a source and a user along a common line;

(b) a decombiner for recovering the plurality of services from the common line;

(c) a detector for detecting a failure condition in at least one of the combiner or the decombiner; and

(d) a switch responsive to the detected failure for bypassing the failed combiner or decombiner to couple at least one service determined to be critical between the source and the user.

### BRIEF DESCRIPTION OF THE DRAWINGS

These and other features of the preferred embodiments of the invention will become more apparent in the following detailed description in which reference is made to the appended drawings wherein:

FIG. 1 is a schematic diagram of a general pair gain system architecture;

FIG. 2 is a schematic diagram of a system according to an embodiment of the present invention; and

FIG. 3 is a schematic diagram of a system according to a further embodiment of the present invention.

### DETAILED DESCRIPTION OF THE INVENTION

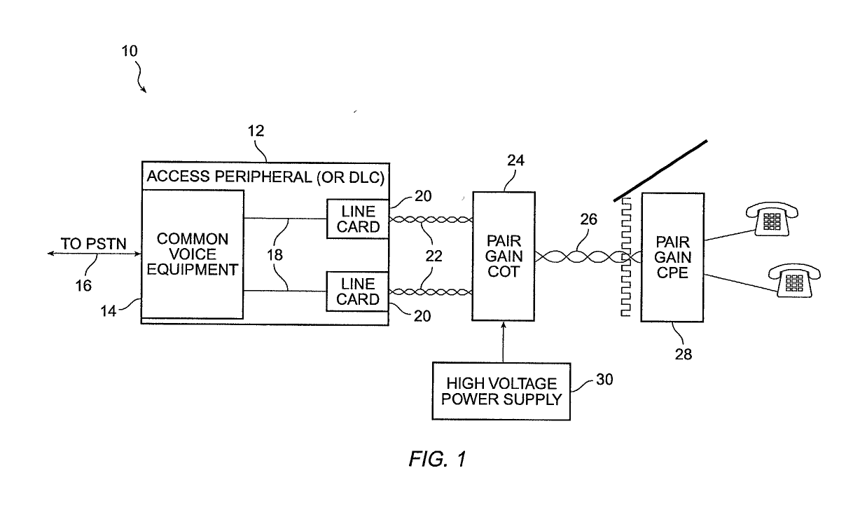

In the following description like numerals refer to like structures in the diagrams. Referring to FIG. 1, a general pair gain system architecture is shown generally by numeral 10. The system comprises an access peripheral or DLC 12 at a central office (CO) that includes common voice equipment 14 for connecting a public switched telephone network (PSTN) 16 to a plurality of single voice channels 18. The signals from the voice channels 18 are interfaced to respective standard copper pairs 22 by respective line cards 20. The signals on these copper pairs 22 are combined by a pair gain COT device 24 into a multiplexed signal and interfaced to a single copper pair 26. A pair gain customer premises equipment (CPE) device 28 at the customer premises receives the multiplexed signal from the single copper pair 26 and de-multiplexes or separates it into the constituent voice signals for coupling to customer equipment such as standard analog telephone terminals, facsimile machines or analog modems. A high voltage source 30 is provided to or is contained within the COT pair gain device 24 and provides power to the CPE 28 via the single copper pair 26. As described in the background above there are certain limitations with the above architecture.

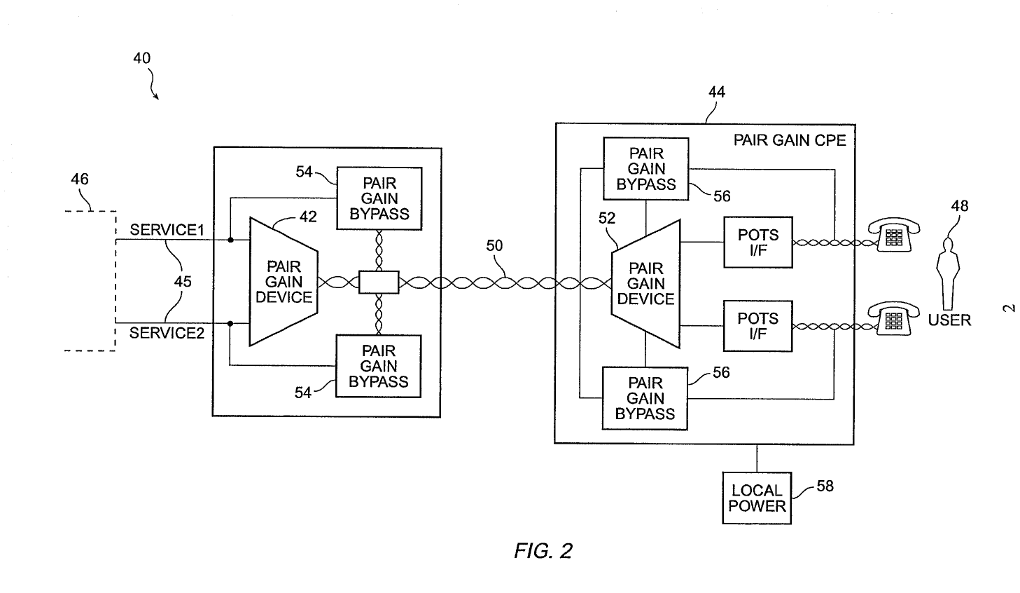

Referring to FIG. 2, an end-to-end architecture for providing at least one service in a multi-service communication system, according to an embodiment of the present invention is shown generally by numeral 40. In particular the system 40 automatically enables POTS service during AC main power failure or pair gain system failure. The system 40 comprises a pair gain device combiner 42 for combining a plurality of services 45 for delivery between a source 46 and a user 48 along a common line 50, a pair gain device decombiner 52 for recovering each of the plurality of services from the common line 50, a detector (not shown) for detecting a failure condition in the pair gain system and a switch 54, 56 responsive to the detected failure for bypassing the failed combiner 42 or decombiner 52 to couple at least one of the services which is deemed to be critical between the source 46 and the user 48.

Failure of the pair gain system may be due to a variety of reasons. These reasons include the loss of loop synchronization between the transmitters and receivers used to communicate the combined services signal on the loop 50, a degradation of the loop transmission characteristics due to a physical fault or interference from other signals, or failure of the local power 58 at the CPE end 44.

There exists a multiplicity of methods for combining several service signals into a combined signal and impressing that signal onto a twisted pair loop. Without diminishing the generality of the system description, if the service signals are POTS voiceband signals, one possible method involves digitally multiplexing digital representations of the voice signals. The voice signals may be -law or A-law encoded pulse code modulation (PCM) signals. The voice signals might be multiplexed into a higher rate bit stream and digital subscriber loop (DSL) technology used to transform the combined bit stream into a signal suitable for transmission on a twisted pair loop. Examples of suitable DSL technologies include integrated services digital network (ISDN), asymmetric DSL (ADSL), symmetric DSL (SDSL), and the like.

As illustrated in FIG. 2 a pair of services 45, service1 and service2, are shown. However, this architecture can be extended to any number of services. The pair gain devices 42 and 52 (i.e., combiner and decombiner) may be implemented as multiplexers/demultiplexers or other similar devices, all of which are standard devices known in the art.

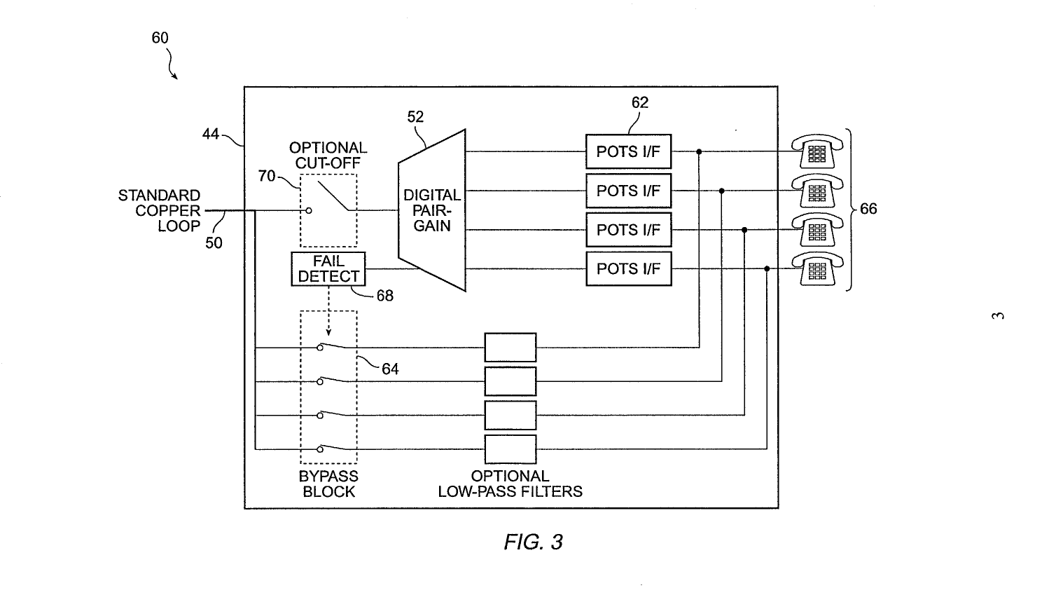

Referring to FIG. 3 a detailed diagram of the system 40 extended to four POTS interfaces 62 at the CPE end 44 is shown generally by numeral 60. (Similar components may be implemented at the CO end.) The system 60 is capable of detecting a failure condition at the CPE 44 and automatically connecting the POTS terminals 66 to the copper pair 50. The system 60 includes a bypass block 64 coupled from the incoming copper pair 50 to one or more of the plurality of telephone terminals 66 and a failure detection block 68 coupled to the digital pair gain decombiner or demultiplexer 52 and the bypass block 64. An optional cut-off switch 70 is connected in series between the incoming copper pair 50 and the digital pair gain demultiplexer 52. This cut-off switch 70 may also be activated by the failure detect block 68 to prevent interference from the decombiner transmitter 52 with the POTS terminals 66.

Typically, the bypass block 64 may be implemented as a number of normally closed relays. Thus under normal operational conditions the relays 64 are energized via the demultiplexer 52 so that the relay contacts are in the open position, allowing the signals along the copper pair 50 to be interfaced to the demultiplexer 52, and the separated POTS signals to be interfaced to the respective telephone CPE 66. Under a failure condition such as loss of power of the demultiplexer 52, power to the relays in the bypass block 64 is lost and the relay contacts close, causing the telephone CPE 66 to be connected directly to the copper pair 50, bypassing the demultiplexer 52. Thus the CPE 66 operates as if only a single POTS line is available. Once power is restored to the demultiplexer 52, the relays are again energized and the bypass block 64 is disconnected.

The COT is also capable of detecting when a failure condition has occurred in the demultiplexer at the CPE end 44 and thus processes any signals from the CPE end as if a single POTS line exists. Thus the architecture described above allows a bypass to occur when no power is available. The architecture can be extended to any number of lines.

The optional cut-off 70 of digital pair-gain path may be implemented to avoid interference. The need for this block 70 is dependent on the compatibility between the DSL or other signal used to carry the combined voice signals and the baseband POTS signals of the POTS terminals. In the case of incompatibility, this block 70 disconnects the DSL or other signal from the decombiner from the copper loop 50.

Optional low pass filters may be used when the optional cut off 70 is not employed and DSL or other signals are still present on the copper loop 50. This may be required to avoid nonlinear demodulation in the telephone equipment 66 and consequent objectionable audible noise.

In a further embodiment of the present invention the access peripheral 12 also implements an architecture for redirection of voice traffic from the pair-gain path to baseband POTS path in case of pair-gain failure.

The present system may be applied equally efficiently to a pairgain COT 24 which receives voice as an analog signal, as to a pairgain COT which receives voice as a digital (PCM) signal.

A priority-based bypass may also be implemented in the pair gain COT 24 (and optionally CPE 28) to enable call continuation during a failure. This capability allows one of multiple conversations to continue uninterrupted when a failure occurs. If more than one POTS line is active when a pair gain system failure occurs, the line with an assigned priority maintains its call. This is accomplished by enabling only the COT (and optionally CPE) bypass corresponding to the voice service line assigned the primary priority.

As described above, a POTS to pair-gain interface according to one aspect of the present invention allows any of the multiple pair-gain lines to be called from the public phone system while in fail-to-POTS mode when no other lines are active, without the need for hunt groups feature at the CO. This feature is implemented by allowing any of the incoming voice channels that are normally combined when pair-gain is active to connect to the baseband POTS service. This allows incoming calls to any of the lines as long as no other lines are active.

Additional features may be implemented by the pair-gain system when using a fail to POTS system of the subject invention, which include: creating the appearance of a busy line when the pair-gain lines cannot be reached due to failure, creating the appearance of a busy line by generating an off-hook indication for the inaccessible line, maintaining a voice channel back to public switched telephone network (PSTN) when failure occurs while phone lines are active (this ensures that calls are not dropped unless the customer end hangs up), generation of “on-hold” tone back to caller so that the line does not go silent suddenly when failure occurs, and a “call waiting”-like option implemented at the line card or CO end pair-gain device allowing multiple PSTN lines to access the pair-gain fail-to-POTS line simultaneously. In the latter case, a tone is generated to the user indicating that another call is coming in. A hook-flash event (i.e., press on hook-switch for about 1 second) indicates the switch to the other line.

It may be seen that with the architecture of the present invention, many new features may be added to existing pair-gain systems heretofore unrealizable under failure conditions of existing pair gain devices.

Although the invention has been described with reference to certain specific embodiments, various modifications thereof will be apparent to those skilled in the art without departing from the spirit and scope of the invention as outlined in the claims appended hereto.

What is claimed is:

1. A system for providing a plurality of telephone services to multiple customer premises equipment via a pair-gain device, said system comprising:
a combiner circuit coupled to combine a plurality of services for delivery between a source and a user along a common line;
a decombiner circuit coupled to recover said plurality of services from said common line and to provide each recovered service to a corresponding customer premises equipment;
a detector circuit coupled to detect a failure condition in at least one of said combiner circuit and said decombiner circuit; and
a switch responsive to said detected failure and coupled to bypass said at least one of said combiner circuit and said decombiner circuit to provide at least one service of said plurality of services that is determined to be critical between said source and said user.

2. The system of claim 1, wherein said plurality of telephone services includes a digital service and an analog service.

3. The system of claim 2, wherein said analog service comprises a voice band service.

4. The system of claim 1, wherein said plurality of telephone services includes a digital data service and a digital voice service.

5. The system of claim 1, wherein said common line comprises a twisted pair copper telephone line.

6. The system of claim 1, wherein said failure condition includes a loss of power.

7. The system of claim 1, wherein said combiner circuit includes a multiplexer and said decombiner circuit includes a demultiplexer.

8. The system of claim 1, wherein said combiner circuit and said decombiner circuit each include an integrated POTS and ADSL transceiver card.

9. The system of claim 1, wherein said switch includes a relay having normally closed contacts.
